(19) United States
(12) Patent Application Publication
(10) Pub. No.: US 2021/0150107 A1
(43) Pub. Date: May 20, 2021

(54) MODELING APPARATUS AND METHOD OF MECHANISTIC FORCE FOR MILLING UNIDIRECTIONAL FIBER REINFORCED POLYMER

(71) Applicant: INDUSTRIAL TECHNOLOGY RESEARCH INSTITUTE, Hsinchu (TW)

(72) Inventors: Jui-Ming CHANG, Taichung City (TW); Shuo-Peng LIANG, Taichung City (TW)

(73) Assignee: INDUSTRIAL TECHNOLOGY RESEARCH INSTITUTE, Hsinchu (TW)

(21) Appl. No.: 16/721,378

(22) Filed: Dec. 19, 2019

(30) Foreign Application Priority Data
Nov. 15, 2019 (TW) 108141516

(51) Int. Cl. G06F 30/27

(52) U.S. Cl. CPC G06F 30/27; G06F 2111/10

(57) ABSTRACT

A modeling method of a cutting force model is provided, including: using a cutting tool to cut a unidirectional fiber reinforced polymer along a circular path; using a measurement member to measure the cutting force on the cutting tool corresponding to the angle between the feeding direction of the cutting tool and the fiber direction of the unidirectional fiber reinforced polymer; and obtaining the functions of the cutting force coefficients in a formula according to the measurement result of the measurement member. With the modeling method, a mechanistic force model can be rapidly established to predict approximate cutting forces of the cutting tool in use.

### CROSS REFERENCE TO RELATED APPLICATIONS

The present application is based on, and claims priority from, Taiwan Patent Application No. 108141516, filed Nov. 15, 2019, the disclosure of which is hereby incorporated by reference herein in its entirety.

### BACKGROUND

### Field of the Disclosure

The application relates in general to a modeling method of mechanistic force, and in particular, to a modeling method of mechanistic force for milling a unidirectional fiber reinforced polymer.

### Description of the Related Art

In recent years, aerospace components made of aluminum alloys have been gradually replaced by composite materials, because the composite materials have light weight and high strength. However, the machining of composite materials currently requires a large number of trials to meet quality-control requirements, resulting in poor processing efficiency and a higher cost. Therefore, how to address the aforementioned problem has become an important issue.

### SUMMARY

To address the deficiencies of conventional products, an embodiment of the disclosure provides a modeling method of a cutting force model, including: using a cutting tool to cut a unidirectional fiber reinforced polymer along a circular path; using a measurement member to measure the cutting force on the cutting tool corresponding to the angle between the feeding direction of the cutting tool and the fiber direction of the unidirectional fiber reinforced polymer; and obtaining the functions of the cutting force coefficients in a formula according to the measurement result of the measurement member.

An embodiment of the disclosure also provides a modeling apparatus connected to a measurement member and configured to constitute a cutting force model of a unidirectional fiber reinforced polymer. The modeling apparatus includes a storage component and a calculating component. The measurement member measures the force of the cutting tool when the cutting tool cuts the unidirectional fiber reinforced polymer along a circular path, and the measurement result can be transmitted to the storage component. The calculating component receives the measurement result, and functions of the cutting force coefficients in a formula can be obtained by the calculating component according to the measurement result.

### BRIEF DESCRIPTION OF DRAWINGS

The disclosure can be more fully understood by reading the subsequent detailed description and examples with references made to the accompanying drawings, wherein:

FIG. 1A is a schematic diagram of a modeling system according to an embodiment of the disclosure;

FIG. 1B is a schematic diagram of a modeling apparatus according to an embodiment of the disclosure;

FIG. 2 is a schematic diagram that represents that a cutting tool cuts a unidirectional fiber reinforced polymer according to an embodiment of the disclosure; and

FIG. 3 is a schematic diagram of simulation values and experimental values according to an embodiment of the disclosure.

### DETAILED DESCRIPTION

The making and using of the embodiments of the modeling apparatus and the modeling method are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

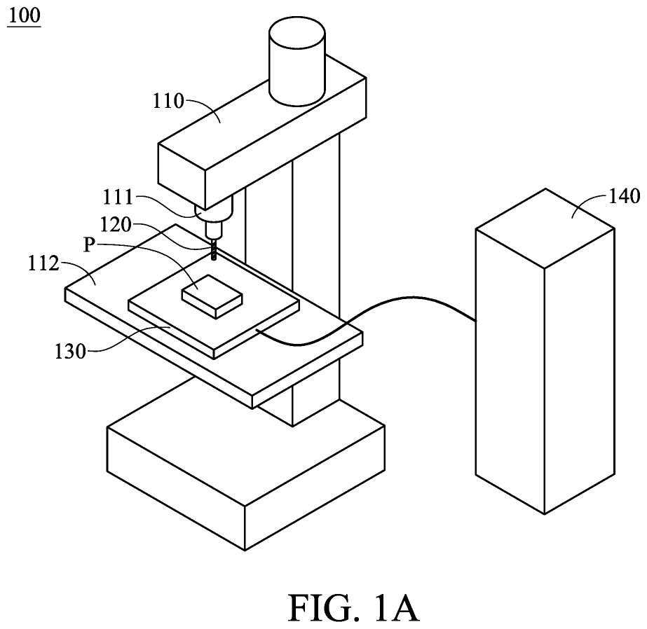

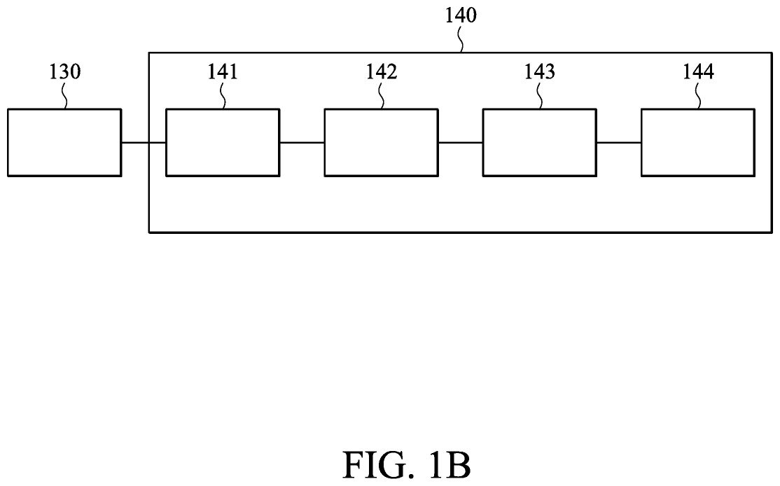

Referring to FIG. 1A, in an embodiment of the disclosure, a modeling system 100 is configured to measure a required force for cutting a unidirectional fiber reinforced polymer P, and obtain a cutting force formula according to the measurement result. Therefore, when the user desires to cut the same unidirectional fiber reinforced polymer in the future, the required force can be calculated according to the aforementioned formula.

As shown in FIG. 1A, the modeling system 100 primarily includes a machine tool 110, a cutting tool 120, a measurement member 130, and a modeling apparatus 140. The cutting tool 120 and the unidirectional fiber reinforced polymer P are respectively disposed on a clamping part 111 and a working table 112 of the machine tool 110. The machine tool 110 can include a rotation motor and a linear motor (not shown), so as to drive the cutting tool 120 to rotate and drive the unidirectional fiber reinforced polymer P to move. In some embodiments, the linear motor is connected to the working table to drive the working table 112 to move relative to the clamping part 111.

The measurement member 130 is assembled on the machine tool 110, and connected to the unidirectional fiber reinforced polymer P or the cutting tool 120. When the cutting tool 120 cuts the unidirectional fiber reinforced polymer P, the measurement member 130 can measure the force of the cutting tool 120 in one or more directions. In this embodiment, the measurement member 130 can measure the force of the cutting tool 120 in a feeding direction, a direction perpendicular to the feeding direction, and a direction along the axis of the cutting tool 120. For example, the measurement member 130 can be a dynamometer, an accelerometer, or other suitable sensor.

Referring to FIGS. 1A and 1B, for example, the modeling apparatus 140 can include a storage component 141, a cutting force coefficient calculating component 142, an analyzing component 143, and a cutting force calculating component 144, wherein the cutting force coefficient calculating component 142, the analyzing component 143 and the cutting force calculating component 144 can consist a single calculating component. The storage component 141 can be a read only memory (ROM), a flash memory, a random access memory (RAM), a disk, or any other suitable optical, magnetic or solid-state computer readable media, as well as a combination thereof. The storage component 141 is electrically connected to the measurement member 130. The cutting force coefficient calculating component 142 is electrically connected to the storage component 141, the analyzing component 143 is electrically connected to the cutting force coefficient calculating component 142, and the cutting force calculating component 144 is electrically connected to the analyzing component 143. The aforementioned connection relationship is an example, and the disclosure is not limited thereto. In some embodiment, the storage component 141 can be integrated into the calculating component, so that the calculating component can storage the data, analyze and calculate, but the disclosure is not limited thereto.

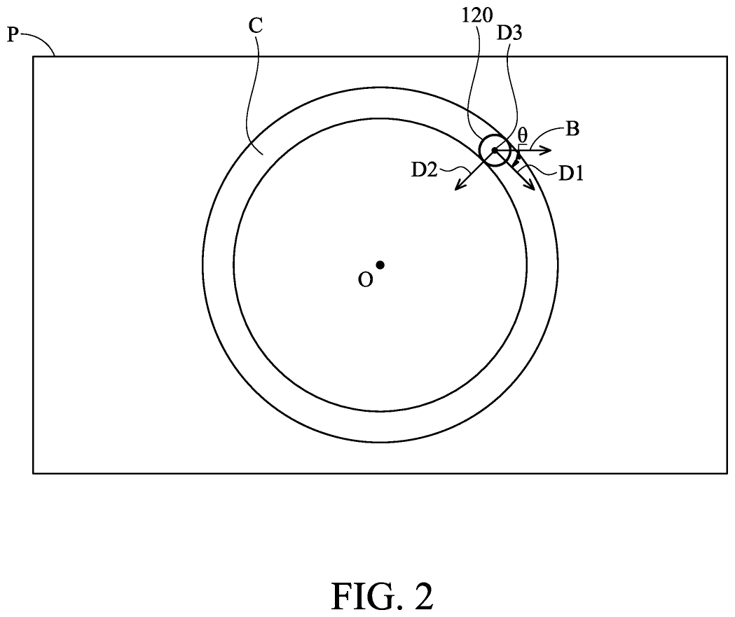

The modeling method is discussed below. First, the machine tool 110 can be actuated to drive the cutting tool 120 to rotate and move. As shown in FIG. 2, the cutting tool 120 cuts the unidirectional fiber reinforced polymer P along a circular path C.

It should be noted that, in this embodiment, since the unidirectional fiber reinforced polymer P is unidirectional, it has a uniform fiber direction B. When the cutting tool 120 cuts the unidirectional fiber reinforced polymer P, the measurement member 130 can measure the force of the cutting tool 120 in the feeding direction D1 corresponding to the included angles θ between the fiber direction B and the feeding direction D1 of the cutting tool 120.

For example, since the circular path C is a circle, the measurement member 130 can measure the force every one degree of the included angle θ between the fiber direction B and the feeding direction D1. Therefore, 360 results (Newton, N) corresponding to the included angle θ can be obtained.

Subsequently, the results can be transmitted to the storage component 141 of the modeling apparatus 140, and the cutting force coefficient calculating component 142 reads the results in the storage component 141 and inputs the results into a cutting force formula (such as the formula from Yusaf Altinatas) to obtain the cutting force coefficients K_{rc} (N*rev-flute/mm²) and Kᵣₑ (N/mm) in the formula:

$${F}_{D 1} = - \frac{Na}{4} {K}_{rc} c - \frac{Na}{π} {K}_{re}$$

In the formula, the term “Fₘ” is the measured force in the direction D1, the term “N” is the number of cutting flutes, the term “a” is the cutting depth (mm), and the term “c” is the feed per flute (mm/rev-flute). When the number of cutting flutes and the cutting depth of the cutting tool 120 are maintained, and the cutting tool 120 cuts the unidirectional fiber reinforced polymer P two or more times along the circular path C in the different feeds per flute, the aforementioned two cutting force coefficients K_{rc} and Kᵣₑ corresponding to the included angles θ can be obtained, for example, by linear regression.

Finally, the analyzing component 143 can obtain the function of the cutting force coefficient K_{rc} and the function of the cutting force coefficient Kᵣₑ corresponding to the included angle θ (i.e. the included angle θ is a parameter of the function of the cutting force coefficients K_{rc} and Kᵣₑ, K=f(θ)) by regression analysis or deep learning. The function can be transmitted to the cutting force calculating component 144. Therefore, when the user desires to simulate the cutting tool 120 cutting the unidirectional fiber reinforced polymer P in the future, he can uses the cutting force calculation component 144 to obtain the force of the cutting tool 120 in the feeding direction D1 according to the aforementioned formula and functions.

Referring to FIG. 2, in this embodiment, when the cutting tool 120 cuts the unidirectional fiber reinforced polymer P, the measurement member 130 can measure the force of the cutting tool 120 in a normal direction D2 corresponding to the included angles θ between the fiber direction B and the feeding direction D1 of the cutting tool 120, wherein the normal direction D2 is perpendicular to the feeding direction D1 of the cutting tool 120 and extended toward a center O of the circular path C.

The measurement results can be transmitted to the storage component 141 of the modeling apparatus 140, and the cutting force coefficient calculating component 142 reads the results in the storage component 141 and inputs the results into the following formula to obtain the cutting force coefficients K_{tc} (N*rev-flute/mm²) and Kₜₑ (N/mm) in the formula corresponding to the different included angles θ:

$${F}_{D 2} = \frac{Na}{4} {K}_{tc} c + \frac{Na}{π} {K}_{te}$$

In the formula, the term “F_{D2}” is the measured force in the direction D2, the term “N” is the number of cutting flutes, the term “a” is the cutting depth (mm), and the term “c” is the feed per flute (mm/rev-flute). When the number of cutting flutes and the cutting depth of the cutting tool 120 are maintained, and the cutting tool 120 cuts the unidirectional fiber reinforced polymer P two or more times along the circular path C in the different feeds per flute, the aforementioned two cutting force coefficients K_{tc} and Kₜₑ corresponding to the included angles θ can be obtained, for example, by linear regression.

The analyzing component 143 can obtain the function of the cutting force coefficient K_{tc} and the function of the cutting force coefficient Kₜₑ corresponding to the included angle θ (i.e. the included angle θ is a parameter of the function of the cutting force coefficients K_{tc} and Kₜₑ, K=f(θ)) by regression analysis or deep learning. The function can be transmitted to the cutting force calculating component 144. Therefore, when the user desires to simulate the cutting tool 120 cutting the unidirectional fiber reinforced polymer P in the future, he can use the cutting force calculation unit 144 to obtain the force of the cutting tool 120 in the normal direction D2 according to the aforementioned formula and functions.

Similarly, when the cutting tool 120 cuts the unidirectional fiber reinforced polymer P, the measurement member 130 can also measure the force of the cutting tool 120 in a axial direction D3 of the cutting tool 120 corresponding to the included angles θ between the fiber direction B and the feeding direction D1 of the cutting tool 120, wherein the axial direction D3 is perpendicular to the feeding direction D1 and the normal direction D2.

The measurement results can be transmitted to the storage component 141 of the modeling apparatus 140, and the cutting force coefficient calculating component 142 reads the results in the storage component 141 and inputs the results into the following formula to obtain the cutting force coefficients K_{ac} (N*rev-flute/mm²) and Kₐₑ (N/mm) in the formula corresponding to the different included angles θ:

$${F}_{D 3} = \frac{N a}{π} {K}_{a c} c + \frac{N a}{2} {K}_{a e}$$

In the formula, the term “F_{D3}” is the measured force in the axial direction D3, the term “N” is the number of cutting flutes, the term “a” is the cutting depth (mm), and the term “c” is the feed per flute (mm/rev-flute). When the number of cutting flutes and the cutting depth of the cutting tool 120 are maintained, and the cutting tool 120 cuts the unidirectional fiber reinforced polymer P two or more times along the circular path C in the different feeds per flute, the aforementioned two cutting force coefficients K_{ac} and Kₐₑ corresponding to the included angles θ can be obtained, for example, by linear regression.

The analyzing component 143 can obtain the function of the cutting force coefficient K_{ac} and the function of the cutting force coefficient Kₐₑ corresponding to the included angle θ (i.e. the included angle θ is a parameter of the function of the cutting force coefficients K_{ac} and Kₐₑ, K=f(θ)) by regression analysis or deep learning. The function can be transmitted to the cutting force calculating component 144. Therefore, when the user desires to simulate the cutting tool 120 cutting the unidirectional fiber reinforced polymer P in the future, he can use the cutting force calculation component 144 to obtain the force of the cutting tool 120 in the axial direction D3 according to the aforementioned formula and functions.

It should be noted that the aforementioned cutting force formulas are merely examples in the embodiment. The user can replace them with other suitable formulas, and obtain the cutting force coefficients using those formulas according to the aforementioned method to constitute the cutting force model.

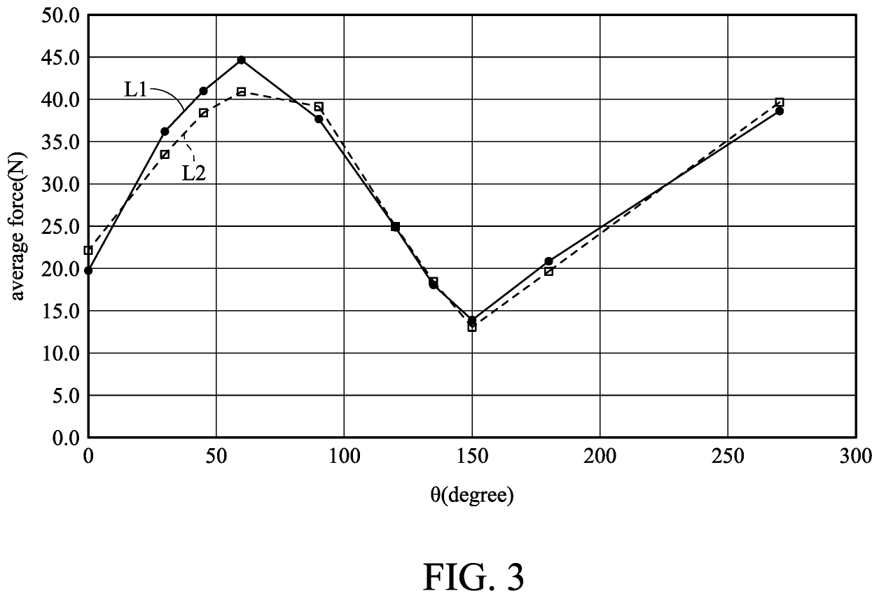

The cutting force model forming by the aforementioned modeling method is confirmed by experimentation. As shown in FIG. 3, taking the force of the cutting tool 120 in the feeding direction D1 as an example, line L1 (the solid line) represents the measured forces of the cutting tool 120, and line L2 (the dotted line) represents the simulated forces from the cutting force model. The trend of the measured forces and the simulated forces are consistent, and the values of the measured force and the simulated forces are close.

In summary, a modeling apparatus connected to a measurement member and configured to constitute a cutting force model of a unidirectional fiber reinforced polymer is provided. The modeling apparatus includes a storage component and a cutting force coefficient calculating component, wherein the storage component is electrically connected to the measurement member, and the cutting force coefficient calculating component is electrically connected to the storage component. The measurement member measures the force of the cutting tool when the cutting tool cuts the unidirectional fiber reinforced polymer along a circular path, and the measurement result can be transmitted to the storage component. The functions of the cutting force coefficients in a formula can be obtained by the cutting force coefficient calculating component according to the measurement result.

The cutting force model can be rapidly constituted through a modeling method by using the aforementioned modeling apparatus. The modeling method includes: using a cutting tool to cut a unidirectional fiber reinforced polymer along a circular path; using a measurement member to measure the force of the cutting tool corresponding to the angle between the feeding direction of the cutting tool and the fiber direction of the unidirectional fiber reinforced polymer; and obtaining the functions of the cutting force coefficients in a formula according to the measurement result of the measurement member.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the disclosure has been described by way of example and in terms of preferred embodiment, it should be understood that the disclosure is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A modeling method of a cutting force model of a unidirectional fiber reinforced polymer, wherein a cutting tool cuts the unidirectional fiber reinforced polymer along a circular path, and the modeling method comprises:
using a measurement member to measure the force of the cutting tool corresponding to the included angle between a feeding direction of the cutting tool and a fiber direction of the unidirectional fiber reinforced polymer; and
obtaining functions of cutting force coefficients in a formula according to the measured force.

2. The modeling method as claimed in claim 1, wherein the included angle is a parameter of the functions of the cutting force coefficients.

3. The modeling method as claimed in claim 1, wherein the formula is used to calculate the force of the cutting tool in the feeding direction, a normal direction and an axial direction, wherein the feeding direction, the normal direction and the axial direction are perpendicular to each other.

4. The modeling method as claimed in claim 1, wherein the formula is a cutting force formula.

5. The modeling method as claimed in claim 1, wherein the functions of the cutting force coefficients in the formula are obtained by regression analysis or deep learning.

6. A modeling apparatus of a cutting force model of a unidirectional fiber reinforced polymer connected to a measurement member, wherein the measurement member measures the force of a cutting tool when the cutting tool cuts the unidirectional fiber reinforced polymer along a circular path and constitutes the cutting force model, and the modeling apparatus comprises:
a storage component, electrically connected to the measurement member to receive the force of the cutting tool corresponding to the included angle between the feeding direction of the cutting tool and the fiber direction of the unidirectional fiber reinforced polymer; and
a calculating component, electrically connected to the storage component to receive the measured force, so as to obtain the functions of the cutting force coefficients in a formula.

7. The modeling apparatus as claimed in claim 6, wherein the included angle is a parameter of the functions of the cutting force coefficients.
